(19) United States
(12) Patent Application Publication
(10) Pub. No.: US 2010/0217649 A1
(43) Pub. Date: Aug. 26, 2010

(54) METHOD, SYSTEM, AND COMPUTER PROGRAM PRODUCT FOR FILTERING OF FINANCIAL ADVERTISING

(75) Inventors: IMAD AHMED, Austin, TX (US); John Durrett, Austin, TX (US)

Correspondence Address: VENABLE LLP, P.O. BOX 34385, WASHINGTON, DC, 20043-9998, US

(73) Assignee: Creditcards.com, Austin, TX (US)

(21) Appl. No.: 12/391,151

(22) Filed: Feb. 23, 2009

(51) Int. Cl. G06Q 30/00; G06Q 10/00; G06Q 40/00

(52) U.S. Cl. 705/10; 705/38; 705/14.66

(57) ABSTRACT

An exemplary embodiment of a method for filtering financial advertising may include receiving advertising groupings from a financial institution, where the groupings include a group identifier and one or more advertisements; receiving identity information from a credit consumer and providing the identity to a credit bureau; the credit bureau retrieves consumer credit history including consumer credit attributes; receiving a list of group identifiers from the credit bureau, where the list is generated by the credit bureau for each of the advertising groupings by adding the group identifier to the list if the credit consumer credit attributes satisfy a group financial criteria provided to the credit bureau by the financial institution; identifying the financial advertisements from the advertising grouping, where the group identifier for the advertising grouping corresponds to the group identifier from the list of from the credit bureau; and providing the financial advertisement to the consumer.

### BACKGROUND

Traditionally, financial advertising was achieved through mass mailings or through bulk electronic mail. What is needed is an improved method, system, and computer program to accurately match or target financial advertisements to individuals in need of credit.

### SUMMARY OF THE INVENTION

The present invention sets forth various exemplary embodiments of apparatuses, systems, methods and computer program products for filtering financial advertisements.

An exemplary embodiment of a method for filtering financial advertising may include receiving at a service provider, one or more advertising groupings from a financial institution, where each advertising grouping includes a group identifier and one or more financial advertisements; receiving at the service provider, a credit consumer identity from a credit consumer user; providing from the service provider, the credit consumer identity of the credit consumer user to a credit bureau, where a credit bureau uses the consumer identity to retrieve a credit consumer credit history including at least one credit consumer credit attribute; receiving at the service provider, a list of group identifiers from the credit bureau, where the credit bureau adds a group identifier to the list if the credit consumer credit attributes satisfy the corresponding group financial criteria provided to the credit bureau by the financial institution; identifying the financial advertisements from the advertising grouping, where the group identifier for the advertising grouping corresponds to the group identifier from the list of the group identifiers from the credit bureau; and providing the financial advertisement to the credit consumer user.

An exemplary embodiment of the invention may include the method where the credit consumer identity includes: a name, an address, and/or a social security number.

An exemplary embodiment of the invention may include the method where the targeted financial advertisement includes one or more of an: Internet advertisement, a telephonic advertisement, a television advertisement, a motion picture advertisement, a mailing advertisement, a radio advertisement, a printed advertisement, a billboard, an outdoor advertisement, a credit card advertisement, a loan advertisement, a credit advertisement, a mortgage advertisement, a home equity advertisement, and/or a line of credit advertisement.

An exemplary embodiment of the invention may include the method where the financial advertisement includes an advertisement for one or more credit card.

An exemplary embodiment of the invention may include the method where the credit consumer credit attribute from the credit consumer user includes one or more of: a Fair Isaac Corporation (FICO) score, a number of trades in collection status, a number of foreclosures, and/or a number of bankruptcies.

An exemplary embodiment of the invention may include the method where the group financial criteria includes one or more of: a Fair Isaac Corporation (FICO) score; a number of trades in collection status; a number of foreclosures; and/or a number of bankruptcies.

An exemplary embodiment of the invention may include the method where the group financial criteria includes satisfying one or more of: a maximum value; a minimum value; and/or a range of values.

Another exemplary embodiment of the invention may include a financial advertising filtering system including: a means for receiving at a service provider, at least one advertising grouping from a financial institution, where each advertising grouping includes a group identifier and at least one financial advertisement; a means for receiving at the service provider, a credit consumer identity from a credit consumer user; a means for providing from the service provider, the credit consumer identity of the credit consumer user to a credit bureau, where a credit bureau uses the credit consumer identity to retrieve a credit consumer credit history including at least one credit consumer credit attribute; a means for receiving at the service provider, a list of group identifiers from the credit bureau, where the credit bureau adds a group identifier to the list if the credit consumer credit attributes satisfy the corresponding group financial criteria provided to the credit bureau by the financial institution; a means for identifying one or more financial advertisements from one or more advertising groupings, where the group identifier for the advertising grouping corresponds to the group identifier from the list of any of the group identifiers from the credit bureau; and a means for providing one or more financial advertisements to the credit consumer user.

An exemplary embodiment of the invention may include the system where the credit consumer identity includes one or more of: a name, an address, and/or a social security number.

An exemplary embodiment of the invention may include the system where the financial advertisement includes one or more of an: Internet advertisement, a telephonic advertisement, a television advertisement, a motion picture advertisement, a mailing advertisement, a radio advertisement, a printed advertisement, a billboard, an outdoor advertisement, a credit card advertisement, a loan advertisement, a credit advertisement, a mortgage advertisement, a home equity advertisement, and/or a line of credit advertisement.

An exemplary embodiment of the invention may include the system where the financial advertisement includes an advertisement for at least one credit card.

An exemplary embodiment of the invention may include the system where the credit consumer credit attribute from the credit consumer user includes one or more of: a Fair Isaac Corporation (FICO) score, a number of trades in collection status, a number of foreclosures, and/or a number of bankruptcies.

An exemplary embodiment of the invention may include the system where the group financial criteria includes one or more of: a Fair Isaac Corporation (FICO) score, a number of trades in collection status, a number of foreclosures, and/or a number of bankruptcies.

An exemplary embodiment of the invention may include the system where the group financial criteria includes satisfying one or more of: a maximum value, a minimum value, and/or a range of values.

Another exemplary embodiment of the invention may include a machine-readable medium that provides instructions, which when executed by a computing platform, causes the computing platform to perform operations includes a method for filtering financial advertising, the method includes: receiving at a service provider, at least one advertising grouping from a financial institution, where each advertising grouping includes a group identifier and at least one financial advertisement; receiving at the service provider, a credit consumer identity from a credit consumer user; providing from the service provider, the credit consumer identity of the credit consumer user to a credit bureau, where a credit bureau uses the consumer identity to retrieve a credit consumer credit history including at least one credit consumer credit attribute; receiving at the service provider, a list of group identifiers from the credit bureau, where the credit bureau adds a group identifier to the list if the credit consumer credit attributes satisfy the corresponding group financial criteria provided to the credit bureau by the financial institution; identifying at least one financial advertisement from the advertising grouping, where the group identifier for the advertising grouping corresponds to the group identifier from the list the group identifiers from the credit bureau; and providing the financial advertisement to the credit consumer user.

An exemplary embodiment of the invention may include the machine-readable medium where the credit consumer identity includes one or more of: a name, an address, and/or a social security number.

An exemplary embodiment of the invention may include the machine-readable medium where financial advertisement includes one or more of an: Internet advertisement, a telephonic advertisement, a television advertisement, a motion picture advertisement, a mailing advertisement, a radio advertisement, a printed advertisement, a billboard, an outdoor advertisement, a credit card advertisement, a loan advertisement, a credit advertisement, a mortgage advertisement, a home equity advertisement, and/or a line of credit advertisement.

An exemplary embodiment of the invention may include the machine-readable medium where the at least one financial advertisement includes an advertisement for at least one credit card.

An exemplary embodiment of the invention may include the machine-readable medium where the credit consumer credit attribute from the credit consumer user includes one or more of: a Fair Isaac Corporation (FICO) score, a number of trades in collection status, a number of foreclosures, and/or a number of bankruptcies.

An exemplary embodiment of the invention may include the machine-readable medium where the group financial criteria includes one or more of: a Fair Isaac Corporation (FICO) score, a number of trades in collection status, a number of foreclosures, and/or a number of bankruptcies.

An exemplary embodiment of the invention may include the machine-readable medium where the group financial criteria includes satisfying one or more of: a maximum value, a minimum value, and/or a range of values.

Another exemplary embodiment of the invention may include a financial advertising filtering method which may include: providing from a financial institution, at least one criteria grouping to a credit bureau, where the criteria grouping includes a group identifier and at least one financial criterion; providing from the financial institution to a service provider at least one advertising grouping, where the advertising grouping includes the group identifier and at least one financial advertisement, where the group identifier is the same for the criteria grouping and the corresponding advertising grouping.

An exemplary embodiment of the invention may include the method where the financial criteria includes a credit attribute.

An exemplary embodiment of the invention may include the method where the financial criteria includes one or more of: a Fair Isaac Corporation (FICO) score, a number of trades in collection status, a number of foreclosures, and/or a number of bankruptcies.

An exemplary embodiment of the invention may include the method where the financial criteria includes satisfying one or more of: a maximum value, a minimum value, and/or a range of values.

Another exemplary embodiment of a financial advertising filtering system may include: a means for providing from a financial institution, at least one criteria grouping to a credit bureau, where the criteria grouping includes a group identifier and at least one financial criterion; a means for providing from the financial institution to a service provider at least one advertising grouping, where the advertising grouping includes the group identifier and at least one financial advertisement, where the group identifier is the same for the criteria grouping and the corresponding advertising grouping.

An exemplary embodiment of the invention may include the system where the financial criteria includes a credit attribute.

An exemplary embodiment of the invention may include the system where the financial criteria includes one or more of: a Fair Isaac Corporation (FICO) score, a number of trades in collection status, a number of foreclosures, and/or a number of bankruptcies.

An exemplary embodiment of the invention may include the system where the financial criteria includes satisfying one or more of: a maximum value, a minimum value, and/or a range of values.

Another exemplary embodiment of the invention may include a machine-readable medium that provides instructions, which when executed by a computing platform, causes the computing platform to perform operations includes a method for filtering financial advertising, the method includes: providing from a financial institution, at least one criteria grouping to a credit bureau, where the criteria grouping includes a group identifier and at least one financial criterion; providing from the financial institution to a service provider at least one advertising grouping, where the advertising grouping includes the group identifier and at least one financial advertisement, where the group identifier is the same for the criteria grouping and the corresponding advertising grouping.

An exemplary embodiment of the invention may include the machine-readable medium where the financial criteria includes a credit attribute.

An exemplary embodiment of the invention may include the machine-readable medium where the financial criteria includes one or more of: a Fair Isaac Corporation (FICO) score, a number of trades in collection status, a number of foreclosures, and/or a number of bankruptcies.

An exemplary embodiment of the invention may include the machine-readable medium where the financial criteria includes satisfying one or more of: a maximum value, a minimum value, and/or a range of values.

Another exemplary embodiment of a financial advertising filtering method includes: receiving at a credit bureau, at least one criteria grouping from a financial institution, where the criteria grouping includes a group identifier and at least one financial criterion; receiving at the credit bureau, a credit consumer identity from a service provider; retrieving a credit consumer credit history using the credit consumer identity; extracting one or more credit attributes from the credit consumer credit history; creating a list of group identifiers where a group identifier is added to the list if the credit attributes from the credit consumer credit history satisfy the financial criterion associated with the grouping; and providing to the service provider the list of group identifiers.

An exemplary embodiment of the invention may include the method where the financial criteria includes a credit attribute.

An exemplary embodiment of the invention may include the method where the financial criterion includes one or more of: a Fair Isaac Corporation (FICO) score, a number of trades in collection status, a number of foreclosures, and/or a number of bankruptcies.

An exemplary embodiment of the invention may include the method where the financial criteria includes satisfying one or more of: a maximum value, a minimum value, and/or a range of values.

An exemplary embodiment of the invention may include the method where the credit attribute includes one or more of: a Fair Isaac Corporation (FICO) score, a number of trades in collection status, a number of foreclosures, and/or a number of bankruptcies.

An exemplary embodiment of the invention may include the method where the credit consumer identity includes one or more of: a name, an address, and/or a social security number.

Another exemplary embodiment of a financial advertising filtering system includes: a means for receiving at a credit bureau, at least one criteria grouping from a financial institution, where the criteria grouping includes a group identifier and at least one financial criterion; a means for receiving at the credit bureau, a credit consumer identity from a service provider; a means for retrieving a credit consumer credit history using the credit consumer identity; a means for extracting at least one credit attribute from the credit consumer credit history; a means for creating a list of group identifiers where a group identifier is added to the list if the credit attributes from the credit consumer credit history satisfy the financial criterion associated with the grouping; and a means for providing to service provider the list of group identifiers.

An exemplary embodiment of the invention may include the system where the financial criteria includes a credit attribute.

An exemplary embodiment of the invention may include the system where the financial criterion includes one or more of: a Fair Isaac Corporation (FICO) score, a number of trades in collection status, a number of foreclosures, and/or a number of bankruptcies.

An exemplary embodiment of the invention may include the system where the financial criteria includes satisfying one or more of: a maximum value, a minimum value, and/or a range of values.

An exemplary embodiment of the invention may include the system where the credit attribute includes one or more of: a Fair Isaac Corporation (FICO) score, a number of trades in collection status, a number of foreclosures, and/or a number of bankruptcies.

An exemplary embodiment of the invention may include the system where the credit consumer identity includes one or more of: a name, an address, and/or a social security number.

Another exemplary embodiment of the invention includes a machine-readable medium that provides instructions, which when executed by a computing platform, causes the computing platform to perform operations includes a method for filtering financial advertising, the method which includes: receiving at a credit bureau, at least one criteria grouping from a financial institution, where the criteria grouping includes a group identifier and at least one financial criterion; receiving at the credit bureau, a credit consumer identity from a service provider; retrieving a credit consumer credit history using the credit consumer identity; extracting one or more credit attributes from the credit consumer credit history; creating a list of group identifiers where a group identifier is added to the list if the credit attributes from the credit consumer credit history satisfy the financial criterion associated with the grouping; and providing to the service provider the list of group identifiers.

An exemplary embodiment of the invention may include the machine-readable medium where the financial criteria includes a credit attribute.

An exemplary embodiment of the invention may include the machine-readable medium where the financial criteria includes one or more of: a Fair Isaac Corporation (FICO) score, a number of trades in collection status, a number of foreclosures, and/or a number of bankruptcies.

An exemplary embodiment of the invention may include the machine-readable medium where the financial criteria includes satisfying one or more of: a maximum value, a minimum value, and/or a range of values.

An exemplary embodiment of the invention may include the machine-readable medium where the credit attribute includes one or more of: a Fair Isaac Corporation (FICO) score, a number of trades in collection status, a number of foreclosures, and/or a number of bankruptcies.

An exemplary embodiment of the invention may include the machine-readable medium where the credit consumer identity includes one or more of: a name, an address, and/or a social security number.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention is apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 depicts an exemplary embodiment of a filtering method, system, and computer program product providing exemplary processing of data between a financial institution, a credit bureau, and a marketing agent;

FIG. 2 depicts an exemplary embodiment of a filtering method, system, and computer program product specifically providing further details of interactions between the marketing agent, the credit bureau, and the credit consumer;

FIG. 3 depicts an exemplary system hardware architecture according to an exemplary embodiment;

FIG. 4 depicts an exemplary system software architecture according to an exemplary embodiment;

FIG.5 depicts an exemplary flowchart describing an exemplary embodiment of a process for providing targeted financial advertisements to a credit consumer;

FIG. 6 depicts an exemplary embodiment of a webpage that may allow entry of credit consumer information;

FIG. 7 depicts an exemplary embodiment of a webpage that may provide all or a subset of a credit consumer's targeted advertisements for credit cards;

FIG. 8 depicts an exemplary embodiment of a computer system that may be used in implementing any of various devices of an exemplary embodiment of the present invention.

### DETAILED DESCRIPTION OF EXEMPLARY EMBODIMENTS OF THE PRESENT INVENTION

An exemplary embodiment of the invention is discussed below including a preferred embodiment, as well as various other exemplary, but non-limiting embodiments. While specific implementations are discussed, it should be understood that this is done for illustration purposes only. A person skilled in the relevant art can recognize that other components and configurations may be used without parting from the spirit and scope of the invention.

### Financial Advertising Filtering Setup

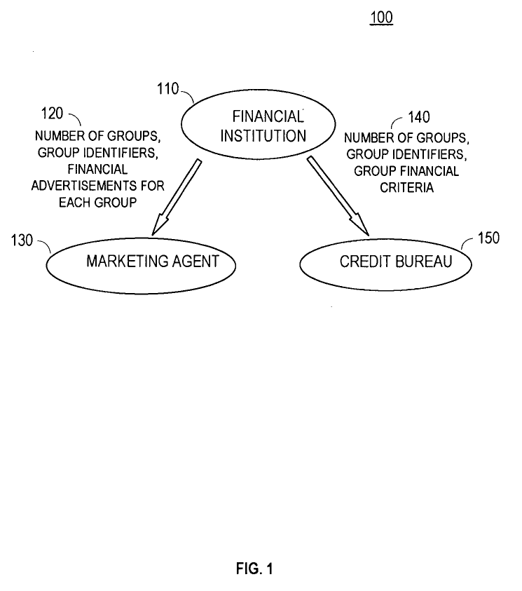

FIG. 1 depicts an exemplary embodiment of an advertising filtering system, method, and computer program product, which according to an exemplary embodiment may be arranged between devices of various exemplary entities, which may include a financial institution 110 (such as e.g., a credit card issuer), a credit bureau 150 (such as e.g., Transunion, Equifax, Experian), and a marketing agent service provider 130 (such as, e.g., CreditCards.com of Austin, Tex.). Although only one financial institution 110, credit bureau 150, and marketing agent service provider 130 are depicted, in an exemplary embodiment multiple combinations of a plurality of financial institutions 110, credit bureaus 150, and/or marketing agent service providers 130 may also be supported.

In an exemplary embodiment, the financial institution 110 may, for example, implement a series of actions described in the following paragraphs.

According to an exemplary embodiment, a financial institution 110 may, for example, sort financial advertisements (such as, e.g., but not limited to, credit cards) that the institution may wish to market using the marketing agent service provider 130 into groupings based on financial criteria. These groupings may be collections of financial products for which the same credit criteria are associated. An example grouping could contain one or more credit cards with the same or substantially similar approval requirements for purposes of advertising referrals. The approval requirements for a particular financial targeted advertisement may not be exactly the same as the approval requirements to qualify for the underlying line of credit.

According to an exemplary embodiment, the financial institution 110 may send the marketing agent service provider 130 financial advertisement data 120, such as, e.g., but not limited to, one or more groups and the number of groups being sent, where the groups contain an identifier for each group (called a group identifier), and/or one or more advertisements relating to one or more financial products. In one exemplary embodiment the financial institution 110 does not send any financial criteria to the marketing agent service provider 130.

In an exemplary embodiment, the financial institution 110 may send a credit bureau 150 financial criteria data 140, such as, e.g., but not limited to, one or more groups, and the number of groups, where the groups contain a group identifier and corresponding financial criteria relating to one or more financial products. In an exemplary embodiment, the group identifiers sent to the marketing agent service provider 130 and to the credit bureau 150 identify the same groupings, in other words, the group identifier identifies both the financial criteria and the associated financial advertisement.

According to an exemplary embodiment, the credit bureau 150 may store the financial institution 110 criteria for processing to identify potential credit consumers 220 for targeted advertising 210. According to an exemplary embodiment, to determine whether a credit consumer 220 should receive particular financial advertising, the credit consumer's credit attributes are compared to, e.g., but not limited to, associated maximum values, minimum values, cutoffs, and/or a range of values, etc. Some examples of credit attributes could include, individually or in combination, e.g., but not limited to, the Fair Isaac Corporation (FICO) score, number of trades in collection status, number of foreclosures, and/or number of bankruptcies, etc. An example criteria could include, e.g., but not limited to, adding “grouping A” to the targeted advertising list if the consumer has a FICO score greater than 600, less than 3 trades in collection status, and exactly zero bankruptcies.

In an exemplary embodiment, the financial institution 110 sends financial criteria only to the credit bureau 150 and not to the marketing agent service provider 130, thereby protecting the confidentiality of the financial institution's credit criteria.

### The Process Flow for Financial Advertisement Filtering

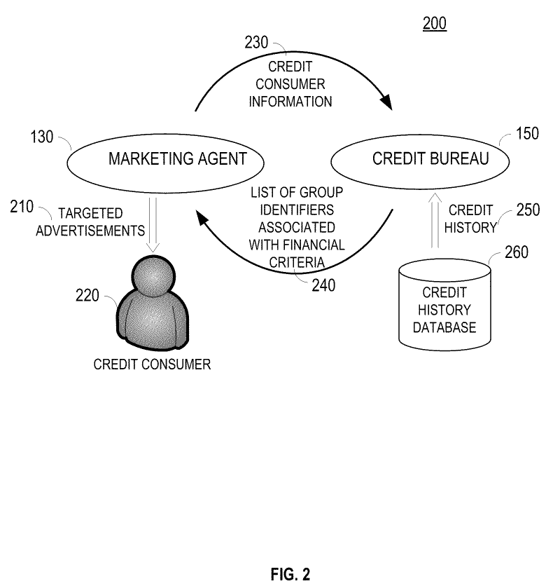

FIG. 2 depicts an exemplary embodiment of the financial advertising filtering method, system, and computer program product specifically providing further details of the interactions between the marketing agent service provider 130, the credit bureau 150, and the credit consumer 220. Although only one marketing agent service provider 130, credit bureau 150, credit consumer 220, and credit history database 260 are depicted, in an exemplary embodiment multiple combinations of a plurality of marketing agent service providers 130, credit bureaus 150, credit consumers 220, and/or credit history databases 260 are supported.

In an exemplary embodiment, the marketing agent service provider 130, may, provide credit consumer information 230 to the credit bureau 150. According to an exemplary embodiment, the credit bureau 150, based on the received credit consumer information 230, may, retrieve the credit consumer's credit history 250, from a credit history database 260. According to an exemplary embodiment, the credit bureau 150, may derive credit consumer's credit attributes from information such as, e.g., but not limited to, the credit consumer's credit history 250. According to an exemplary embodiment, the credit bureau 150 may compare the credit consumer's credit attributes with, e.g., but not limited to, financial criteria from the financial institution 110, to determine a list of corresponding group identifiers 240 for which the credit consumer's financial attributes satisfy the financial institution's credit criteria. According to an exemplary embodiment, the credit bureau 150 may provide to the marketing agent service provider 130 e.g., but not limited to, the list of group identifiers that correspond to the groups for which the credit consumer's financial attributes satisfy the appropriate financial criteria 240. According to an exemplary embodiment, the marketing agent service provider 130 may provide, based on the supplied list 240 from the credit bureau 150, e.g., but not limited to, targeted advertisements 210 to the credit consumer 220 at a device 340.

In an exemplary embodiment, the credit consumer's private financial information is protected from exposure to e.g., the marketing agent service provider 130, as only the credit bureau 150 gains access to the credit consumer's private financial attribute information; the marketing agent service provider 130 never receives or accesses any private financial information about the credit consumer.

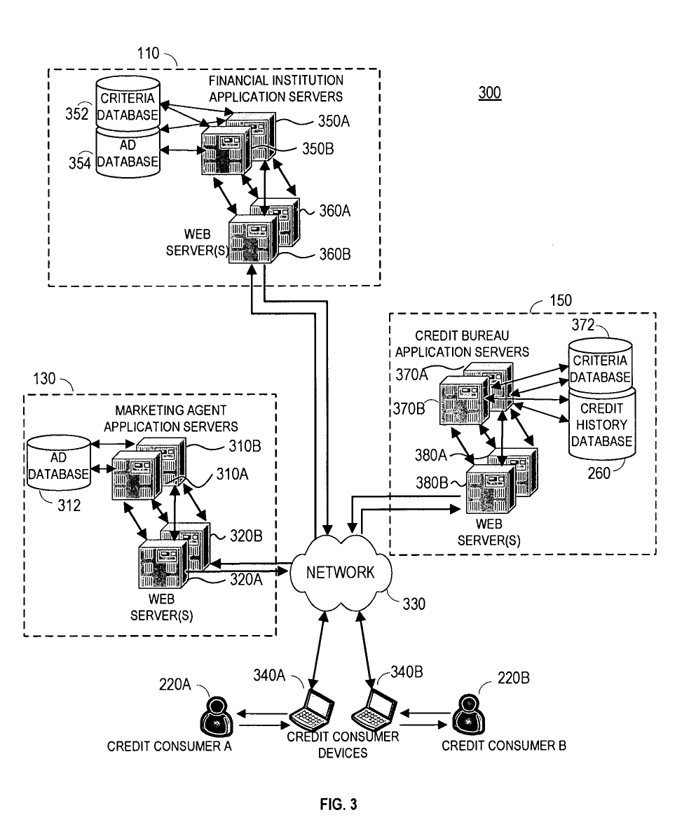

FIG. 3 depicts an exemplary embodiment of an advertisement filtering system hardware and network architecture. In an exemplary embodiment, credit consumers 220a, 220b may communicate with the marketing agent service provider 130 using, e.g., but not limited to, devices 340a, 340b though a network 330, to, e.g., but not limited to, marketing agent service provider servers 320a, 320b. In an exemplary embodiment, credit consumers 220a, 220b may communicate with the financial institution 110 using, e.g., but not limited to, devices 340a, 340b though a network 330, to, e.g., but not limited to, financial institution servers 360a, 360b. According to an exemplary embodiment, the marketing agent service provider 130 may communicate with the credit bureau 150 using, e.g., but not limited to, servers 320a, 320b through a network 330, to e.g., but not limited to, credit bureau servers 380a, 380b. According to an exemplary embodiment, the financial institution 110 may communicate with the credit bureau 150 using e.g., but not limited to, servers 360a, 360b through a network 330, to e.g., but not limited to, credit bureau servers 380a, 380b. According to an exemplary embodiment, the financial institution 110 may communicate with the marketing agent service provider 130 using e.g., but not limited to, servers 360a, 360b through a network 330, to e.g., but not limited to, marketing agent service provider servers 320a, 320b. In an exemplary embodiment, the financial institution application servers 350a, 350b, may read, modify, and/or delete data from a repository of data such as, e.g., but not limited to, a criteria database 352 and/or an advertisement database 354, etc. In an exemplary embodiment, the credit bureau application servers 370a, 370b may read, modify, and/or delete data from a repository of data such as, e.g., but not limited to, a credit history database 260 and/or a criteria database 372, etc. In an exemplary embodiment, the financial institution ad database 354 values are provided to marketing agent service provider ad database 312. In an exemplary embodiment, the financial institution criteria database 352 values are provided to credit bureau criteria database 371. In an exemplary embodiment, the marketing agent service provider application servers 370a, 370b may read, modify, and/or delete data from a repository of data such as, e.g., but not limited to, an advertisement database 312 and other associated data storage. In an exemplary embodiment, the financial institution application servers 350a, 350b may communicate with the web servers 360a, 360b as well as the network 330. In an exemplary embodiment, the marketing agent service provider application servers 310a, 310b may communicate with the web servers 320a, 320b as well as the network 330. In an exemplary embodiment, the credit bureau application servers 370a, 370b may communicate with the web servers 380a, 380b as well as the network 330. In an exemplary embodiment, hardware and network architecture 300 may also include, e.g., but not limited to, network hardware such as hardware firewalls, load balancing servers, backup servers, routers, hubs, backup communication links, etc., and/or any additional needed hardware (none of which is labeled). In an exemplary embodiment network 330 may include the Internet and/or proprietary intranet(s). Although only one or two are depicted, in an exemplary embodiment, multiple combinations of a plurality of marketing agents service providers 130, credit bureaus 150, credit consumers 220, web servers 320, 360, 380, application servers 310, 350, 370, credit consumer devices 340, databases 260, 312, 342, 352, 372, and/or networks 330 may be supported.

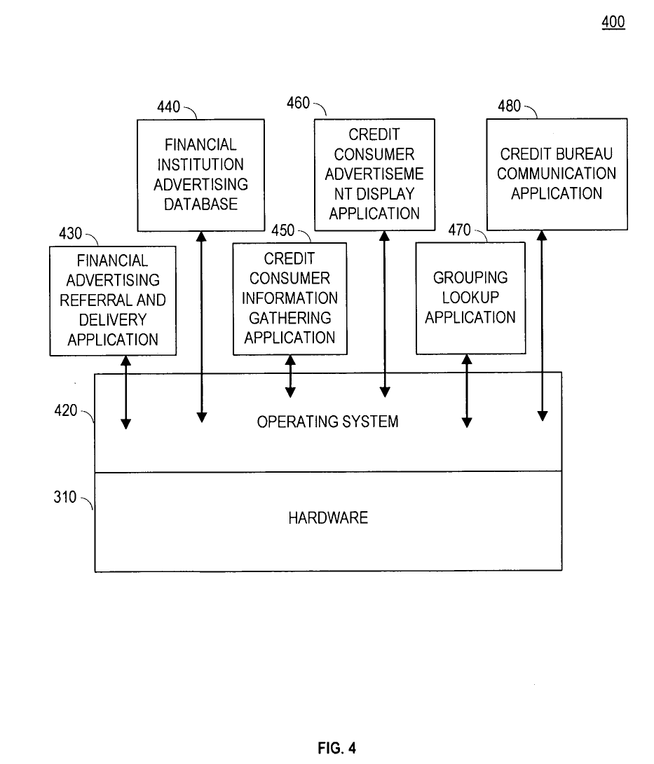

FIG. 4 depicts an exemplary embodiment of an advertisement filtering system software architecture. In an exemplary embodiment, an operating system 420, such as, e.g., but not limited to MICROSOFT® WINDOWS® NT/98/2000/XP/Vista, Unix, Linux, and/or Mac OS, etc., may be installed on an appropriate hardware platform 310. In an exemplary embodiment, the marketing agent service provider 130 may have software applications running on device 310 with operating system 420. In an exemplary embodiment, the software applications may include, e.g., but are not limited to, a financial advertising referral and delivery application 430, a credit consumer information gathering application 450, a credit consumer advertisement display application 460, a group lookup application 470, a credit bureau communication application 480, a financial institution advertising database 440, and/or other software applications necessary to perform advertisement filtering. In an exemplary embodiment, the financial institution application servers 350, and/or the credit bureau servers 370, may have similar hardware and/or software applications not depicted.

In an exemplary embodiment, the credit bureau 150 may have software which may assist the marketing agent service provider 130 in displaying the financial institution's financial advertisements to appropriate credit consumers 220. The exemplary software may first, extract the appropriate attributes from a credit consumer's credit file 250. Then, for example, in an exemplary embodiment, the software may determine whether the credit consumer attributes satisfy the financial institution's criteria to match the credit consumer 220 with one or more of the above mentioned groupings. Where the groupings include a collection of financial products for which the same or substantially similar credit criterion are associated. Finally, in an exemplary embodiment, the software could, for example, but not limited to, send to the marketing agent service provider 130 a list of group identifiers 240 for which the credit consumer's attributes satisfy the corresponding financial institution criteria. The list of group identifiers 240 may be used to locate financial advertising 210 targeted for specific credit consumers 220 whose attributes satisfy the financial institution criteria. According to one exemplary embodiment, similar software could be used at the marketing agent service provider 130 and the financial institution 110.

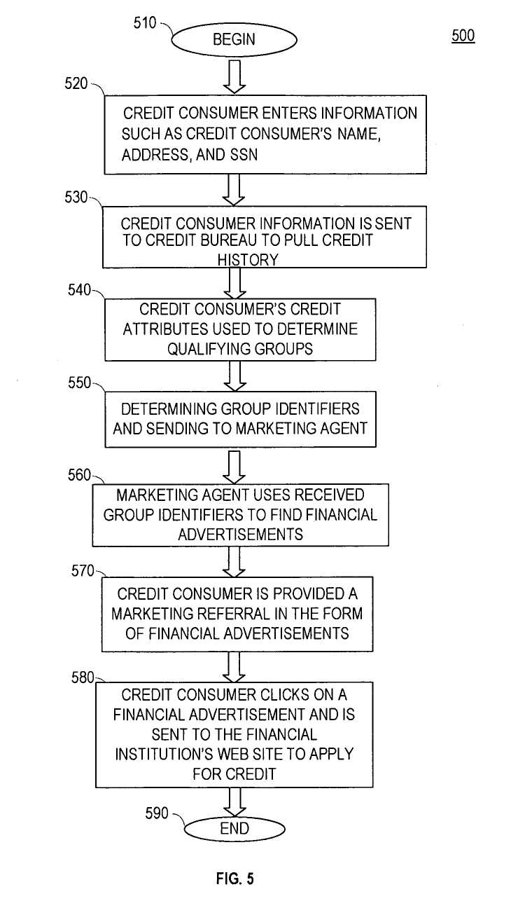

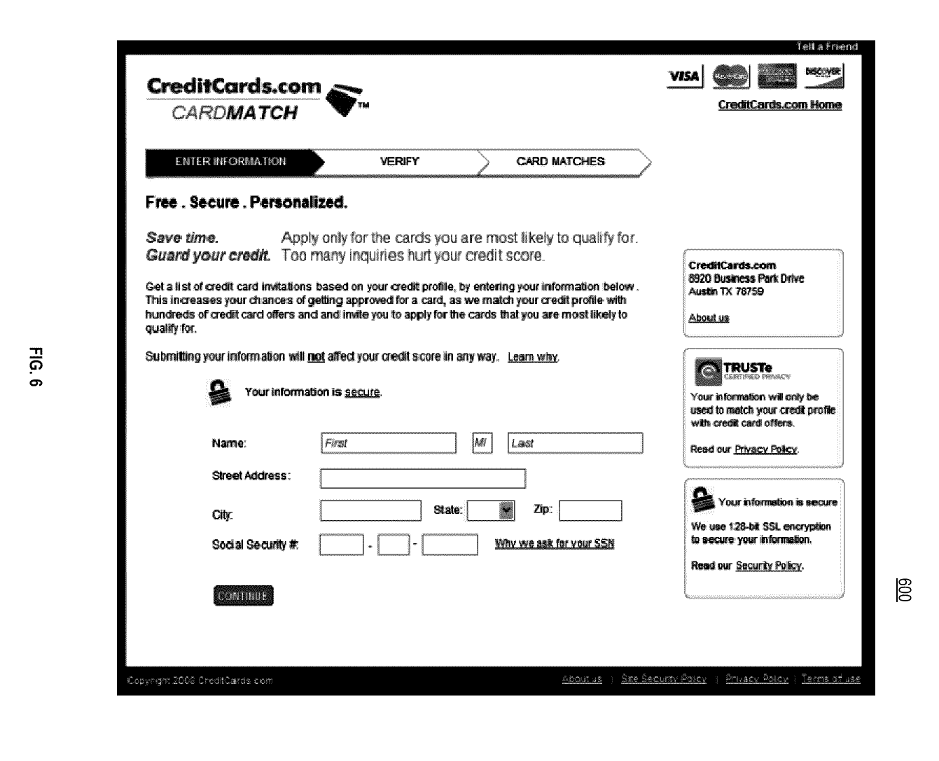

FIG. 5 depicts an exemplary flow diagram 500 illustrating an exemplary process of providing targeted advertising according to an exemplary embodiment of the invention. In an exemplary embodiment, FIG. 5 may begin with 510 and may continue immediately with 520. According to an exemplary embodiment, a credit consumer 220 may request information about obtaining credit (i.e., requesting targeted advertising, 210). In an exemplary embodiment, once credit information is requested, identifiable information about the credit consumer may be collected 520. For example, a credit consumer could, at device 340, click on a URL link for advertisement filtering and may be provided, for example, e.g., a webpage that may allow collection of credit consumer information an example is shown and described further below with reference to FIG. 6 diagram 600. From 520, flow diagram 500 may continue with 530. In an exemplary embodiment, in 530, the credit consumer's information 230 (e.g., but not limited to, name, address, and social security number) may be sent via a secure connection to a credit bureau 150. According to an exemplary embodiment, the credit bureau 150 may use the credit consumer's information 230 to retrieve, for example, the credit consumer's credit history 250 from credit history database 260. According to an exemplary embodiment, once the credit history 250 is retrieved, for example, the appropriate credit attributes may be extracted from the credit consumer's credit history 250. From 530, flow diagram 500 may continue with 540.

In an exemplary embodiment, in 540, the credit consumer's credit attributes input at device 340 or obtained from database 260 may be compared at device 370 with the financial institution's criteria (e.g., but not limited to, maximum, minimum, or a range of values) of database 372 to determine group identifiers corresponding to groups for which the credit consumer's attributes satisfy the financial institutions criteria. In an exemplary embodiment, in 550, the credit bureau 150 may send a list of the determined group identifiers 240 to device 310 of the marketing agent service provider 130. From 550, flow diagram 500 may continue with 560.

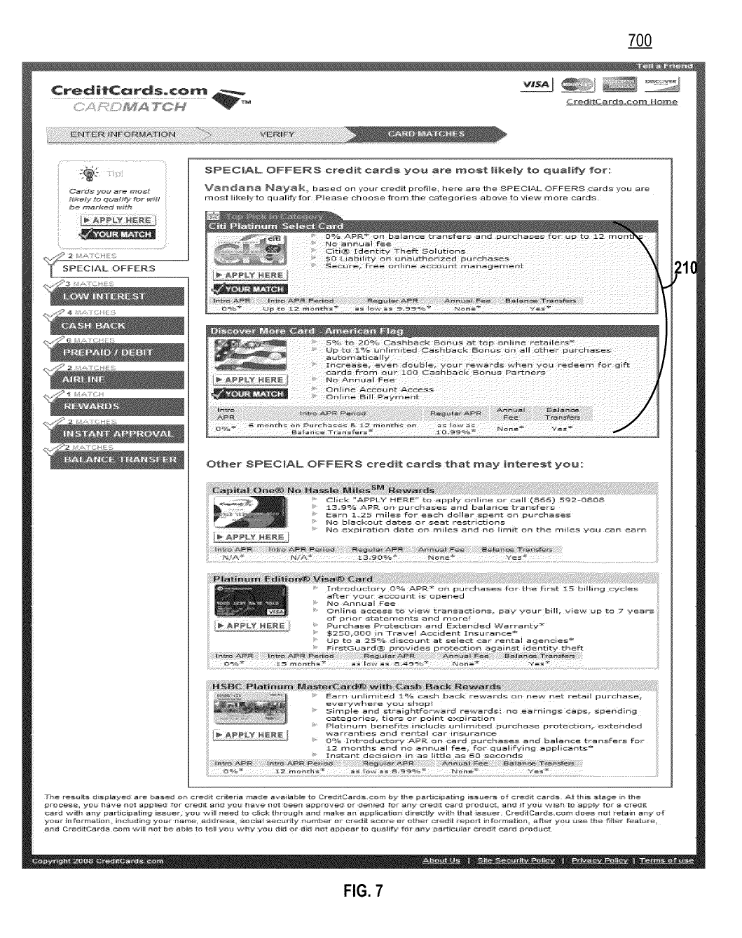

In an exemplary embodiment, in 560, the device 310 of the marketing agent service provider 130 having been provided the list of group identifiers 240 from device 370 of the credit bureau 150 may retrieve targeted financial advertisements 210 using the associated group identifiers. In an exemplary embodiment, in 570, the marketing agent service provider 130 may provide the credit consumer 220 the retrieved financial advertisements 210 through e.g., but not limited to, a webpage 700 viewed by credit consumer 220 at device 340. In an exemplary embodiment, in 370, the credit consumer 220, at device 340, may click on a financial advertisement 210 (e.g., but not limited to a credit card as shown in the screen shot 700 of FIG. 7). The credit consumer 220, at device 340, may be, for example, redirected to a financial institution's website where the credit consumer 220, at device 340, can complete a credit application for e.g., but not limited to, a credit card. In one exemplary embodiment, no personally identifiable information about the credit consumer is sent by the marketing agent service provider 130 to the financial institution 110.

FIG. 6 depicts an exemplary embodiment of a secure webpage 600, which may allow the credit consumer 220, at device 340, to enter information such as, e.g., but not limited to, a name, an address, and/or a social security number, etc.

FIG. 7 depicts an exemplary embodiment of a webpage 700 that provides all or a subset of, for example, credit card advertisements to a credit consumer 220 at device 340. In an exemplary embodiment, in 700, the top two credit cards are the credit consumer's targeted advertisements 210. In an exemplary embodiment, the credit consumer 220 may be informed that he or she is “most likely to qualify for” the presented financial advertisement 210. In this example, the credit consumer 220 may also be advised that there is no guarantee that he or she is approved, for any of the presented credit cards.

In an exemplary embodiment, the targeted financial advertisements to a credit consumer can, for example, take the form of but not limited to an Internet advertisement (e.g., but not limited to, a web page, a banner, a frame, an email, an instant message, a text message, an RSS feed, a pop-up, and/or a pop-under, etc.), a telephonic advertisement, a television advertisement, a motion picture advertisement, a mailing advertisement, a radio advertisement, a printed advertisement (e.g., but not limited to, a flyer, a magazine, a newspaper, a sponsored advertisement, a covert advertisement (e.g., but not limited to, product placement in a motion picture, television, webcast, etc.) and/or a brochure, etc.), a billboard; an outdoor advertisement (e.g., but not limited to a kiosk, tradeshow, and/or an event, etc.), a credit card advertisement, a loan advertisement, a credit advertisement, a mortgage advertisement, a home equity advertisement, and/or a line of credit advertisement.

### Hardware for Financial Advertisement Filtering

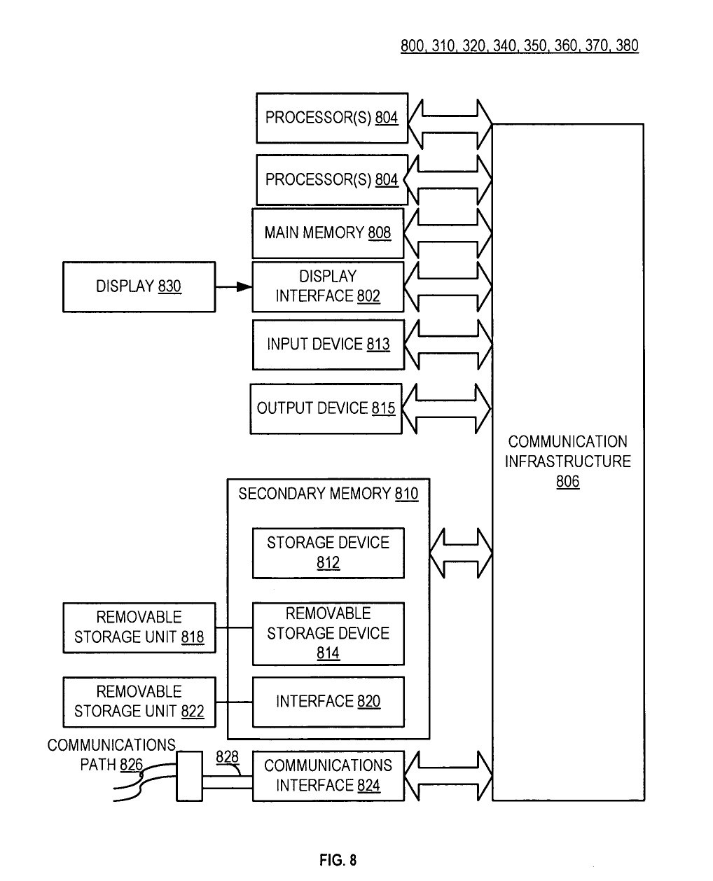

FIG. 8 depicts an exemplary computer system that may be used in implementing an exemplary embodiment of the present invention. Specifically, FIG. 8 depicts an exemplary embodiment of a computer system 800 that may be used in computing devices such as, e.g., but not limited to, client or server devices 310, 320, 340, 350, 360, 370, 380, among others. FIG. 8 depicts an exemplary embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 800 is shown in FIG. 8, depicting an exemplary embodiment of a block diagram of an exemplary computer system useful for implementing the present invention. Specifically, FIG. 8 illustrates an example computer 800, which in an exemplary embodiment may be, e.g., (but not limited to) a personal computer (PC) system running an operating system 420 such as, e.g., (but not limited to) MICROSOFT® WINDOWS® NT/98/2000/XP/Vista etc. available from MICROSOFT® Corporation of Redmond, Wash., U.S.A. However, the invention may not be limited to these platforms. Instead, the invention may be implemented on any appropriate computer system running any appropriate operating system 420 such as, e.g., but not limited to, Mac OS, Unix, Linux, etc. In one exemplary embodiment, the present invention may be implemented on a computer system operating as discussed herein. An exemplary computer system, computer 800 is shown in FIG. 8. Other components of the invention, such as, e.g., (but not limited to) a computing device, a communications device, an interactive television (iTV), a mobile phone, a mobile device, a wired device, a wireless device, a firewall, a peer-to-peer device, a network appliance, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 8.

The computer system 800 may include one or more processors, such as, e.g., but not limited to, processor(s) 804. The processor(s) 804 may be connected to a communication infrastructure 806 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 800 may include a display interface 802 that may forward, e.g., but not limited to, graphics, text, and other data, etc., from the communication infrastructure 806 (or from a frame buffer, etc., not shown) for display on the display unit 830.

The computer system 800 may also include, e.g., but may not be limited to, a main memory 808, random access memory (RAM), and a secondary memory 810, etc. The secondary memory 810 may include, for example, (but not limited to) a hard disk drive 812 and/or a removable storage drive 814, representing a floppy diskette drive, a magnetic tape drive, an optical disk drive, a compact disk drive (CD-ROM), a digital versatile disk (DVD), a thumbdrive, a flash memory device, etc. The removable storage drive 814 may, e.g., but not limited to, read from and/or write to a removable storage unit 818 in a well known manner. Removable storage unit 818, also called a program storage device or a computer program product, may represent, e.g., but not limited to, a floppy disk, magnetic tape, optical disk, compact disk, a storage area network (SAN), etc. which may be read from and written to by removable storage drive 814. The removable storage unit 818 may include a computer usable storage medium having stored therein computer software and/or data.

In alternative exemplary embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 822 and interfaces 820, which may allow software and data to be transferred from the removable storage unit 822 to computer system 800.

Computer 800 may also include an input device such as, e.g., (but not limited to) a mouse or other pointing device such as a digitizer, and a keyboard or other data entry device (none of which are labeled).

Computer 800 may also include output devices, such as, e.g., (but not limited to) display 830, and display interface 802. Computer 800 may include input/output (I/O) devices such as, e.g., (but not limited to) communications interface 824, cable 828 and communications path 826, etc. These devices may include, e.g., but not limited to, a network interface card, and modems (neither are labeled). Communications interface 824 may allow software and data to be transferred between computer system 800 and external devices.

In this document, the terms “computer program medium” and “computer readable medium” may be used to generally refer to media such as, e.g., but not limited to removable storage drive 814, a hard disk installed in hard disk drive 812, flash memory, CD-ROM, etc. These computer program products may provide software to computer system 800. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

The term “database” may refer to any commercially available database (from vendors such as, e.g., but not limited to Microsoft, Oracle, IBM, Sybase, etc), an open source database, a proprietary database, or a combination of the previous three.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents. Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A financial advertising filtering method comprising:
receiving at a service provider device, at least one advertising grouping from a financial institution device, wherein said at least one advertising grouping comprises a group identifier and at least one financial advertisement;
receiving at said service provider device, a credit consumer identity from a credit consumer user;
providing from said service provider device, said credit consumer identity of the credit consumer user to a credit bureau device, wherein a credit bureau uses said consumer identity to retrieve a credit consumer credit history comprising at least one credit consumer credit attribute;
receiving at said service provider device, a list of any said group identifiers from the credit bureau device, wherein said list is generated by the credit bureau by adding, for each of said at least one advertising grouping, said group identifier to said list if said at least one credit consumer credit attributes satisfy a group financial criteria provided to the credit bureau device by the financial institution device;
identifying said at least one financial advertisement from said at least one advertising grouping, wherein the group identifier for said at least one advertising grouping corresponds to said group identifier from said list of any of said group identifiers from the credit bureau device; and
providing said at least one financial advertisement to the credit consumer user.

2. The method of claim 1, wherein the credit consumer identity comprises at least one of:
a name;
an address; or
a social security number.

3. The method of claim 1, wherein said at least one targeted financial advertisement comprises at least one of:
an Internet advertisement;
a telephonic advertisement;
a television advertisement;
a motion picture advertisement;
a mailing advertisement;
a radio advertisement;
a printed advertisement;
a billboard;
an outdoor advertisement;
a credit card advertisement;
a loan advertisement;
a credit advertisement;
a mortgage advertisement;
a home equity advertisement;
a line of credit advertisement.

4. The method of claim 1, wherein said at least one financial advertisement comprises an advertisement for at least one credit card.

5. The method of claim 1, wherein the credit consumer credit attribute from the credit consumer user comprises at least one of:
a Fair Isaac Corporation (FICO) score;
a number of trades in collection status;
a number of foreclosures; or
a number of bankruptcies.

6. The method of claim 1, wherein the group financial criteria comprises at least one of:
a Fair Isaac Corporation (FICO) score;
a number of trades in collection status;
a number of foreclosures; or
a number of bankruptcies.

7. The method of claim 1, wherein the group financial criteria comprises satisfying at least one of:
a maximum value;
a minimum value; or
a range of values.

8. A financial advertising filtering system comprising:
means for receiving at a service provider device, at least one advertising grouping from a financial institution device, wherein said advertising grouping comprises a group identifier and at least one financial advertisement;
means for receiving at said service provider device, a credit consumer identity from a credit consumer user;
means for providing from said service provider device, said credit consumer identity of the credit consumer user to a credit bureau device, wherein a credit bureau uses said credit consumer identity to retrieve a credit consumer credit history comprising at least one credit consumer credit attribute;
means for receiving at said service provider device, a list of any said group identifiers from the credit bureau device, wherein said list is generated by the credit bureau by adding, for each of said at least one advertising grouping, said group identifier to said list if said at least one credit consumer credit attributes satisfy a group financial criteria provided to the credit bureau device by the financial institution device;
means for identifying said at least one financial advertisement from said at least one advertising grouping, wherein the group identifier for said at least one advertising grouping corresponds to said group identifier from said list of any of said group identifiers from the credit bureau device; and
means for providing said at least one financial advertisement to the credit consumer user.

9. The system of claim 8, wherein the credit consumer identity comprises at least one of:
a name;
an address; or
a social security number.

10. The system of claim 8, wherein said at least one financial advertisement comprises at least one of:
an Internet advertisement;
a telephonic advertisement;
a television advertisement;
a motion picture advertisement;
a mailing advertisement;
a radio advertisement;
a printed advertisement;
a billboard; or
an outdoor advertisement;
a credit card advertisement;
a loan advertisement;
a credit advertisement;
a mortgage advertisement;
a home equity advertisement;
a line of credit advertisement.

11. The system of claim 8, wherein said at least one financial advertisement comprises an advertisement for at least one credit card.

12. The system of claim 8, wherein said credit consumer credit attribute from the credit consumer user comprises at least one of:
a Fair Isaac Corporation (FICO) score;
a number of trades in collection status;
a number of foreclosures; or
a number of bankruptcies.

13. The system of claim 8, wherein the group financial criteria comprises at least one of:
a Fair Isaac Corporation (FICO) score;
a number of trades in collection status;
a number of foreclosures; or
a number of bankruptcies.

14. The system of claim 8, wherein the group financial criteria comprises satisfying at least one of:
a maximum value;
a minimum value; or
a range of values.

15. A machine-readable medium that provides instructions, which when executed by a computing platform, causes said computing platform to perform operations comprising a method for filtering financial advertising, the method comprising:
receiving at a service provider device, at least one advertising grouping from a financial institution device, wherein said at least one advertising grouping comprises a group identifier and at least one financial advertisement;
receiving at said service provider device, a credit consumer identity from a credit consumer user;
providing from said service provider device, said credit consumer identity of the credit consumer user to a credit bureau device, wherein a credit bureau uses said consumer identity to retrieve a credit consumer credit history comprising at least one credit consumer credit attribute;
receiving at said service provider device, a list of any said group identifiers from the credit bureau device, wherein said list is generated by the credit bureau by adding, for each of said at least one advertising grouping, said group identifier to said list if said at least one credit consumer credit attributes satisfy a group financial criteria provided to the credit bureau device by the financial institution device;
identifying said at least one financial advertisement from said at least one advertising grouping, wherein the group identifier for said at least one advertising grouping corresponds to said group identifier from said list of any of said group identifiers from the credit bureau device; and
providing said at least one financial advertisement to the credit consumer user.

16. The machine-readable medium of claim 15, wherein the credit consumer identity comprises at least one of:
a name;
an address; or
a social security number.

17. The machine-readable medium of claim 15, wherein said at least one financial advertisement comprises at least one of:
an Internet advertisement;
a telephonic advertisement;
a television advertisement;
a mailing advertisement;
a radio advertisement;
a printed advertisement;
a billboard; or
an outdoor advertisement;
a credit card advertisement;
a loan advertisement;
a credit advertisement;
a mortgage advertisement;
a home equity advertisement;
a line of credit advertisement.

18. The machine-readable medium of claim 15, wherein said at least one financial advertisement comprises an advertisement for at least one credit card.

19. The machine-readable medium of claim 15, wherein said credit consumer credit attribute from said credit consumer user comprises at least one of:
a Fair Isaac Corporation (FICO) score;
a number of trades in collection status;
a number of foreclosures; or
a number of bankruptcies.

20. The machine-readable medium of claim 15, wherein the group financial criteria comprises at least one of:
a Fair Isaac Corporation (FICO) score;
a number of trades in collection status;
a number of foreclosures; or
a number of bankruptcies.

21. The machine-readable medium of claim 15, wherein the group financial criteria comprises satisfying at least one of:
a maximum value;
a minimum value; or
a range of values.

22. A financial advertising filtering method comprising:
providing from a financial institution device, at least one criteria grouping to a credit bureau device, wherein said criteria grouping comprises a group identifier and at least one financial criterion;
providing from said financial institution device to a service provider device at least one advertising grouping based on said criteria grouping, wherein said advertising grouping comprises said group identifier and at least one financial advertisement, wherein the group identifier is the same for the criteria grouping and the advertising grouping when said financial criterion corresponds to said financial advertisement.

23. The method of claim 22, wherein said financial criteria comprises a credit attribute.

24. The method of claim 22, wherein said financial criteria comprises at least one of:
a Fair Isaac Corporation (FICO) score;
a number of trades in collection status;
a number of foreclosures; or
a number of bankruptcies.

25. The method of claim 22, wherein said financial criteria comprises satisfying at least one of:
a maximum value;
a minimum value; or
a range of values.

26. A financial advertising filtering system comprising:
means for providing from a financial institution device, at least one criteria grouping to a credit bureau device, wherein said criteria grouping comprises a group identifier and at least one financial criterion;
means for providing from said financial institution device to a service provider device at least one advertising grouping based on said criteria grouping, wherein said advertising grouping comprises said group identifier and at least one financial advertisement, wherein the group identifier is the same for the criteria grouping and the advertising grouping when said financial criterion corresponds to said financial advertisement.

27. The system of claim 26, wherein said financial criteria comprises a credit attribute.

28. The system of claim 26, wherein said financial criteria comprises at least one of:
a Fair Isaac Corporation (FICO) score;
a number of trades in collection status;
a number of foreclosures; or
a number of bankruptcies.

29. The system of claim 26, wherein said financial criteria comprises satisfying at least one of:
a maximum value;
a minimum value; or
a range of values.

30. A machine-readable medium that provides instructions, which when executed by a computing platform, causes said computing platform to perform operations comprising a method for filtering financial advertising, the method comprising:
providing from a financial institution device, at least one criteria grouping to a credit bureau device, wherein said criteria grouping comprises a group identifier and at least one financial criterion;
providing from said financial institution device to a service provider device at least one advertising grouping based on said criteria grouping, wherein said advertising grouping comprises said group identifier and at least one financial advertisement, wherein the group identifier is the same for the criteria grouping and the advertising grouping when said financial criterion corresponds to said financial advertisement.

31. The machine-readable medium of claim 30, wherein said financial criteria comprises a credit attribute.

32. The machine-readable medium of claim 30, wherein said financial criteria comprises at least one of:
a Fair Isaac Corporation (FICO) score;
a number of trades in collection status;
a number of foreclosures; or
a number of bankruptcies.

33. The machine-readable medium of claim 30, wherein said financial criteria comprises satisfying at one of:
a maximum value;
a minimum value; or
a range of values.

34. A financial advertising filtering method comprising:
receiving at a credit bureau device, at least one criteria grouping from a financial institution device, wherein said criteria grouping comprises a group identifier and at least one financial criterion;
receiving at said credit bureau device, a credit consumer identity from a service provider device;
retrieving a credit consumer credit history using said credit consumer identity;
extracting at least one credit attribute from said credit consumer credit history;
creating a list of any said group identifiers comprising, for each said grouping, adding said group identifier to said list if said credit attributes from said credit consumer credit history satisfy said financial criterion associated with said grouping; and
providing to a service provider device said list of any said group identifiers.

35. The method of claim 34, wherein said financial criteria comprises a credit attribute.

36. The method of claim 34, wherein said financial criterion comprises at least one of:
a Fair Isaac Corporation (FICO) score;
a number of trades in collection status;
a number of foreclosures; or
a number of bankruptcies.

37. The method of claim 34, wherein said financial criteria comprises satisfying at least one of:
a maximum value;
a minimum value; or
a range of values.

38. The method of claim 34, wherein said credit attribute comprises at least one of:
a Fair Isaac Corporation (FICO) score;
a number of trades in collection status;
a number of foreclosures; or
a number of bankruptcies.

39. The method of claim 34, wherein said credit consumer identity comprises at least one of:
a name;
an address; or
a social security number.

40. A financial advertising filtering system comprising:
means for receiving at a credit bureau device, at least one criteria grouping from a financial institution device, wherein said criteria grouping comprises a group identifier and at least one financial criterion;
means for receiving at said credit bureau device, a credit consumer identity from a service provider device;
means for retrieving a credit consumer credit history using said credit consumer identity;
means for extracting at least one credit attribute from said credit consumer credit history;
means for creating a list of any said group identifiers comprising, for each said grouping, means for adding said group identifier to said list if said credit attributes from said credit consumer credit history satisfy said financial criterion associated with said grouping; and
means for providing to a service provider device said list of any said group identifiers.

41. The system of claim 40, wherein said financial criteria comprises a credit attribute.

42. The system of claim 40, wherein said financial criterion comprises at least one of:
a Fair Isaac Corporation (FICO) score;
a number of trades in collection status;
a number of foreclosures; or
a number of bankruptcies.

43. The system of claim 40, wherein said financial criteria comprises satisfying at least one of:
a maximum value;
a minimum value; or
a range of values.

44. The system of claim 40, wherein said credit attribute comprises at least one of:
a Fair Isaac Corporation (FICO) score;
a number of trades in collection status;
a number of foreclosures; or
a number of bankruptcies.

45. The system of claim 40, wherein said credit consumer identity comprises at least one of:
a name;
an address; or
a social security number.

46. A machine-readable medium that provides instructions, which when executed by a computing platform, causes said computing platform to perform operations comprising a method for filtering financial advertising, the method comprising:
receiving at a credit bureau device, at least one criteria grouping from a financial institution device, wherein said criteria grouping comprises a group identifier and at least one financial criterion;
receiving at said credit bureau device, a credit consumer identity from a service provider device;
retrieving a credit consumer credit history using said credit consumer identity;
extracting at least one credit attribute from said credit consumer credit history;
creating a list of any said group identifiers comprising, for each said grouping, adding said group identifier to said list if said credit attributes from said credit consumer credit history satisfy said financial criterion associated with said grouping; and
providing to a service provider device said list of any said group identifiers.

47. The machine-readable medium of claim 46, wherein said financial criteria comprises a credit attribute.

48. The machine-readable medium of claim 46, wherein said financial criteria comprises at least one of:
a Fair Isaac Corporation (FICO) score;
a number of trades in collection status;
a number of foreclosures; or
a number of bankruptcies.

49. The machine-readable medium of claim 46, wherein said financial criteria comprises satisfying at least one of:
a maximum value;
a minimum value; or
a range of values.

50. The machine-readable medium of claim 46, wherein said credit attribute comprises at least one of:
a Fair Isaac Corporation (FICO) score;
a number of trades in collection status;
a number of foreclosures; or
a number of bankruptcies.

51. The machine-readable medium of claim 46, wherein said credit consumer identity comprises at least one of:
a name;
an address; or
a social security number.
